(19) United States
(12) Patent Application Publication
(10) Pub. No.: US 2016/0319098 A1
(43) Pub. Date: Nov. 3, 2016

(54) ARTICLE COMPRISING POLYLACTIC ACID AND A FILLER

(71) Applicant: SA DES EAUX MINERALES D'EVIAN SAEME, Evian-les-Bains (FR)

(72) Inventors: Cédric Beal, Messery (FR); Frédéric Chivrac, Paris (FR)

(21) Appl. No.: 15/102,328

(22) PCT Filed: Dec. 19, 2013
(86) PCT No.: PCT/IB2013/002982

§ 371 Date: Jun. 7, 2016

(51) Int. Cl. C08K 3/26; B29C 51/00; B65D 1/40; C08K 3/00; C08L 67/04

(52) U.S. Cl. CPC C08K 3/26; C08K 3/0033; C08L 67/04; B65D 1/40; B29C 51/002; C08K 2003/265; B29K 2067/046

(57) ABSTRACT

The invention concerns an article in a material comprising polylactic acid, said article comprising a thermoformed part. The material further comprises at least one mineral filler.

The invention concerns an article in a material comprising polylactic acid, said article comprising a thermoformed part. The material further comprises at least one mineral filler.

Polylactic Acid (PLA) is a thermoplastic polymer made from renewable resources. It has a significant biodegradability. PLA plastic sheets are used to make thermoformed containers.

Thermoforming is performed by applying a plug to force a heated material into a mold cavity. During thermoforming the material is stretched and the initial thickness of the material is reduced. Higher form factors (deepness dimension/section dimension) of thermoformed articles are obtained with higher stretch ratios. Mechanical properties of the stretched zone decrease as the thickness decreases. Stretching inhomogeneity can also be a source of mechanical properties degradations by generating local defaults. There is a need in articles made with PLA with significant form factors, while presenting good mechanical properties, for example due to good thickness profiles and/or due to good homogeneity after stretching.

Besides, some articles might require some specific properties such as snapability (ability to separate multipack containers under flexural solicitation). Such a property is usually obtained on containers production lines during precut steps. Precut steps involve implementing a mechanical trimming tool that impacts and penetrates the plastic sheet with a controlled precut depth. Implementing this step is particularly difficult with PLA since it is a brittle material. Thus, cracks appear on containers edges and on the container surface along precut lines. Consequently, it is hardly possible to separate the cups without affecting the integrity of the container. There is a need for PLA articles, which present an improved snapability, for example with brittleness decrease, to produce multipack containers.

Document WO 2011/085332 describes some materials comprising PLA, starch and calcium carbonate and suggests thermoforming. There is however no information of thermoformed articles and stretching ratios. There is a need for PLA articles comprising a thermoformed part and for processes thereto that present significant stretching ratios.

Document EP 776927 describes films made of a material comprising PLA and calcium carbonate or titanium oxide. There is however no information about thermoforming and stretching ratios. There is a need for PLA articles comprising a thermoformed part and for processes thereto that present significant stretching ratios. Document US 2012/0035287 describes materials comprising PLA, a copolymer and calcium carbonate and suggests thermoforming. There is however no information of thermoformed articles and stretching ratios. There is a need for PLA articles comprising a thermoformed part and for processes thereto that present significant stretching ratios.

The invention addresses at least one of the problems or needs above with an article in a material comprising polylactic acid, said article comprising a thermoformed part, wherein:
the material comprises:
   from 40% to 90% of polylactic acid, and
   from 10% to 60% by weight of at least at least one mineral filler,
the thermoformed part has a total stretch ratio of at least 2.5, preferably at least 3, preferably at least 4, preferably at least 5.

The invention also concerns processes that are adapted to prepare the articles. The invention also concerns the use of the at least one mineral filler in the PLA material, with the above proportions, in an article comprising a thermoformed part having a total stretch ratio of at least 2.5, preferably at least 3, preferably at least 4, preferably at least 5.

It has been surprisingly found that the articles and/or the process and/or the use of the invention allow good mechanical properties such as compression resistance and/or good thickness profiles, and/or good homogeneity and/or control of thickness profiles and/or good other properties such as snapability.

Without being bound to any theory it is believed that mineral fillers help to control the thermoforming of the PLA, this resulting in improved properties mentioned above. PLA is a semi-crystalline polymer. It means that above its glass transition temperature, an initial neat PLA product, such as a neat PLA sheet, which is originally almost entirely amorphous, can crystallize. It is believed that during a thermoforming process, such crystallization is accelerated by stretching upon the action of a plug, which orientates the macromolecular chains and induce the formation of PLA crystals. This generates an increase of the PLA elongation viscosity, known as strain hardening. Depending on the localization within the thermoformed part of the article, the chain orientation can vary. PLA in direct contact with the plug is not significantly stretched, and thus remains almost amorphous. On the opposite, in the middle the thermoformed part of the article, the stretching is high, leading to a strong orientation of the chains, and resulting in a high crystallinity. Such variations complicate the control of the process and result in quite uncontrolled thickness profiles, with some possible defects. Moreover, the higher the stretching ratio, the more complicated the control of the thermoforming process is. In the thermoformed articles with quite high stretch ratios the strain hardening is very significant. As a consequence, with such high stretch ratios, it is difficult to obtain a significant amount of PLA material at the bottom or the article, and this results in low mechanical resistance. It has been found that thanks to the mineral fillers, PLA crystallization is more homogeneous and lower compared to neat PLA, whatever the stretching ratio. As a consequence, it leads to a more controlled thermoforming process, with good control of the thickness profile, and thus it leads to improved mechanical performance.

### Definitions

In the present application a non-foamed polylactic acid (PLA) material refers to polylactic acid substantially depleted of gas inclusions, either directly in the PLA or in microspheres embedded in the PLA. Non-foamed PLA has typically a density of higher than 1.2. Non-foamed PLA is also referred to as “compact PLA”.

In the present application a foamed polylactic acid (PLA) material refers to polylactic acid comprising gas inclusions, preferably directly in the PLA, typically as opposed to gas inclusions in microspheres embedded in the PLA. Foamed PLA has typically a density of up to 1.2, preferably of at less than 1.2, preferably of up to 1.1.

In the present application snapability (or snap ability) refers to the ability of a a part of the article to be divisible along a precut line under flexural solicitation.

In the present application “additives” refer to products that can be added to polylactic acid or other thermoplastic materials, different from mineral fillers.

In the present application the “total stretch ratio” refers to the ratio between the surface of the article opening, corresponding to the thermoforming area of a sheet, and the surface of the developed thermoformed part, corresponding to the surface of the plastic in contact with a mold.

In the present application the “local stretch ratio” or “local draw ratio” refers to the stretch ratio at a local zone of the thermoformed part. The local stretch ratio can be estimated by dividing the local thickness in the thermoformed part by the initial thickness before thermoforming. Non thermoformed parts, such as flanges, typically have this initial thickness.

Material structure

The material can have a single layer structure or a multi-layers structure, for example a by-layer structure. Such structures are typically obtained by thermoforming corresponding single layer sheets or multi-layers sheets.

The material can have for example a structure having a first layer comprising the polylactic acid and the mineral filler, and a second layer comprising a thermoplastic, preferably polylactic acid and being substantially free of mineral filler. Such arrangements of layers are typically appropriate for articles to be used with food contact. For example in food containers the second layer can be an internal protection layer with food contact. The weight ratio between the layers can be for example of from 1/99 to 50/50, preferably from 5/95 to 20/80, preferably from 10/90 to 30/70.

In a particular embodiment the material is a non-foamed polylactic acid material comprising calcium carbonate and having a density between 1.31 to 2.01 for a mineral content varying from 10% to 70%, preferably between 1.40 to 1.71 for mineral content varying from 20% to 50%, preferably from 30% to 50%.

It is mentioned that the material can comprise a non polylactic acid materbatch polymer, preferably polyethylene, or Ethylene-Vinyl Acetate. The material can comprise further additives.

### Polylactic Acid

Polylactic Acid (PLA) polymers are known by the one skilled in the art and are commercially available. These are typically obtained by polymerization of lactic acid monomers. The lactic acid monomer is typically obtained by a microbiological process, involving micro-organisms such as bacteria. An appropriate PLA polymer is for example a PLA comprising at least 96% by weight of L-Lactide units and optionally up to 4% D-Lactide units.

### Mineral Filler

The material comprises at least one mineral filler. Any mineral filler that can be introduced in thermoplastic materials can be typically used, and are known by the one skilled in the art and available as such on the market. Examples of appropriate mineral fillers are calcium carbonates of natural or synthetic origin, magnesium carbonate, zinc carbonate, mixed salts of magnesium and calcium such as dolomites, limestone, magnesia, barium sulfate, calcium sulfates, magnesium and aluminum hydroxides, silica, wollastonite, clays and other silica-alumina compounds such as kaolins, silico-magnesia compounds such as talc, mica, solid or hollow glass beads, metallic oxides such as zinc oxide, iron oxides, titanium oxide and, more particularly, those selected from natural or precipitated calcium carbonates such as chalk, calcite, marble or mixtures or associations thereof.

The mineral filler is typically in the form of particles of the mineral compound, for example obtained by grinding, for example by a wet grinding process or by a dry grinding process. The particle size, preferably the weight-average particle size, can for example comprised between 10 nm and 100 μm, preferably between 100 nm and 50 μm, preferably between 1 μm and 10 μm.

In a preferred embodiment the mineral filler is a treated ground or precipitated mineral filler, for example a ground or precipitated calcium carbonate, or a mixture thereof. The mineral filler, for example calcium carbonate, can have a particle size distribution such that d₉₈ is lower than or equal to 50 μm, preferably lower or equal to 25 μm, preferably lower or equal to 7 μm, and a d₅₀ is lower or equal to 10 μm, preferably lower or equal to 7 μm, preferably having a d₉₈ of 25 μm and a d₅₀ of 7 μm, preferably lower or equal to 3 μm. d₉₈ means that the 98% by weight of the particles have a diameter of lower than or equal to the value. d₅₀ means that the 50% by weight of the particles have a diameter of lower than or equal to the value.

In a preferred embodiment, the calcium carbonate is a treated calcium carbonate, for example treated with a hydrophobic agent. The hydrophobic agent can be selected from the group consisting of pentanoic acid, hexanoic acid, heptanoic acid, octanoic acid, nonanoic acid, decanoic acid, undecanoic acid, lauric acid, tridecanoic acid, myristic acid, pentadecanoic acid, palmitic acid, heptadecanoic acid, stearic acid, nonadecanoic acid, arachidic acid, heneicosylic acid, behenic acid, tricosylic acid, lignoceric acid and mixtures thereof. Preferably the hydrophobising agent is selected from the group consisting of octanoic acid, decanoic acid, lauric acid, myristic acid, palmitic acid, stearic acid, arachidic acid and mixtures thereof and most preferably the hydrophobising agent is selected from the group consisting of myristic acid, palmitic acid, stearic acid and mixtures thereof. More preferably, the hydrophobic agent comprises a mixture of two aliphatic carboxylic acids having between 5 and 24 carbon atoms, with one aliphatic carboxylic acid which is stearic acid.

The material comprises from 10% to 60% by weight of the at least one mineral filler. The amount by weight of mineral filler can be for example of from 10% to 20%, or from 20% to 30%, or from 30% to 35%, or from 35% to 40%, or from 40% to 45%, or from 45% to 50%, or from 50% to 60%. In a preferred embodiment the amount is of from 20% to 50% by weight. The material comprises from 40% to 90% by weight of PLA. The amount by weight of PLA can be for example of from 40% to 50%, or from 50% to 55%, or form 55% to 60%, or from 60% to 65%, or from 65% to 70%, or from 70% to 80% or from 80% to 90%. In a preferred embodiment the amounts is of from 50% to 80% by weight.

The mineral filler can be added in the form of masterbatches, wherein the mineral filler particles are dispersed in a polymer matrix, for example PLA, polyethylene, or a polymer of ethylenically unsaturated monomers, such as an ethylene vinyl acetate copolymer.

### Impact Modifier

The material can comprise at least one impact modifier. Such compounds are known by the one skilled in the art, and available on the market as such. They typically modify the mechanical properties of thermoplastics by increasing the tensile stress of said thermoplastics. Various mechanisms can be involved, such as cavitation upon impact or diffused energy released upon impact. Compounds that have such properties are typically appropriate. Examples of impact modifiers include alkyl sulfonates, aromatic-aliphatic polyesters, poly(butylene adipate-co-terephthalate), for example those described in document EP 2065435, ethylene copolymers, for example described in document WO 2011119639, Acetyl TriButyl citrate, Triethyl citrate, Polybutylene Succinate, PolyVinyl Alcohol (PVA), ethylene vinyl acetate, hydrogenated soil oil.

In a preferred embodiment the impact modifier is a core/shell polymeric compound or an alkyl sulfonate compound.

In a preferred embodiment the material comprises from 0.01% to 20% by weight of impact modifier, preferably from 0.1% to 10%, preferably from 0.5 to 5%.

Impact modifiers can be added in the form of masterbatches, wherein the impact modifier is dispersed in a polymer matrix, for example PLA or a polymer of ethylenically unsaturated monomers, such as an ethylene vinyl acetate copolymer.

The core-shell polymeric compound, also referred to as core-shell copolymer, is typically in the form of fine particles having an elastomer core and at least one thermoplastic shell, the particle size being generally less than 1 micron and advantageously between 150 and 500 nm, and preferably from 200 nm to 450 nm. The core-shell copolymers may be monodisperse or polydisperse.

By way of example of the core, mention may be made of isoprene homopolymers or butadiene homopolymers, copolymers of isoprene with at most 3 mol % of a vinyl monomer and copolymers of butadiene with at most 35 mol % of a vinyl monomer, and preferable 30 mmol % or less. The vinyl monomer may be styrene, an alkylstyrene, acrylonitrile or an alkyl(meth)acrylate. Another core family consists of the homopolymers of an alkyl (meth)acrylate and the copolymers of an alkyl(meth)acrylate with at most 35 mol % of a vinyl monomer, and preferable 30 mol % or less. The alkyl(meth)acrylate is advantageously butyl acrylate. Another alternative consists in an all acrylic copolymer of 2-octylacrylate with a lower alkyl acrylate such as n-butyl-, ethyl-, isobutyl- or 2-ethylhexyl-acrylate. The alkyl acrylate is advantageously butyl acrylate or 2-ethylhexyl-acrylate or mixtures thereof. According to a more preferred embodiment, the comonomer of 2-octylacrylate is chosen among butyl acrylate and 2-ethylhexyl acrylate. The vinyl monomer may be styrene, an alkylstyrene, acrylonitrile, butadiene or isoprene. The core of the copolymer may be completely or partly crosslinked. All that is required is to add at least difunctional monomers during the preparation of the core; these monomers may be chosen from poly(meth)acrylic esters of polyols, such as butylene di(meth)acrylate and trimethylolpropane trimethacrylate. Other difunctional monomers are, for example, divinylbenzene, trivinylbenzene, vinyl acrylate and vinyl methacrylate. The core can also be crosslinked by introducing into it, by grafting, or as a comonomer during the polymerization, unsaturated functional monomers such as anhydrides of unsaturated carboxylic acids, unsaturated carboxylic acids and unsaturated epoxides. Mention may be made, by way of example, of maleic anhydride, (meth)acrylic acid and glycidyl methacrylate.

The shells are typically styrene homopolymers, alkylstyrene homopolymers or methyl methacrylate homopolymers, or copolymers comprising at least 70 mol % of one of the above monomers and at least one comonomer chosen from the other above monomers, vinyl acetate and acrylonitrile. The shell may be functionalized by introducing into it, by grafting or as a comonomer during the polymerization, unsaturated functional monomers such as anhydrides of unsaturated carboxylic acids, unsaturated carboxylic acids and unsaturated epoxides. Mention may be made, for example, of maleic anhydride, (meth)acrylic acid and glycidyl methacrylate. By way of example, mention may be made of core-shell copolymers (A) having a polystyrene shell and core-shell copolymers (A) having a PMMA shell. The shell could also contain functional or hydrophilic groups to aid in dispersion and compatibility with different polymer phases. There are also core-shell copolymers (A) having two shells, one made of polystyrene and the other, on the outside, made of PMMA. Examples of copolymers (A) and their method of preparation are described in the following U.S. Pat. No. 4,180,494, U.S. Pat. No. 3,808,180, U.S. Pat. No. 4,096,202, U.S. Pat. No. 4,260,693, U.S. Pat. No. 3,287,443, U.S. Pat. No. 3,657,391, U.S. Pat. No. 4,299,928 and U.S. Pat. No. 3,985,704.

The core/shell ratio can be for example in a range between 10/90 and 90/10, more preferably 40/60 and 90/10 advantageously 60/40 to 90/10 and most advantageously between 70/30 and 95/15.

Examples of appropriate core/shell impact modifiers include Biostrength ranges, for example Biostrength 150, marketed by Arkema.

### Further Additives

The material can comprise further additives. Herein further additives are understood as compounds different from impact modifiers and mineral fillers. Additives that can be used include for example:
aspect modifiers, such as pigments or colorants,
stabilizers,
lubricants,
mixtures or associations thereof.

Pigments can be for example TiO₂ pigments, for example described in document WO 2011119639.

The further additives can be added in the form of masterbatches, wherein the additive is dispersed in a polymer matrix, for example PLA or a polymer of ethylenically unsaturated monomers, such as an ethylene vinyl acetate copolymer.

Further additives, if present, in the material can be typically present in an amount of 0.1% to 15% by weight, for example in an amount of 1% to 10% by weight.

### Article Structure

The article of the invention comprises a thermoformed part having a stretch ratio of at least 2.5, preferably at least 3, preferably at least 4, preferably at least 5. The article can comprise a part that has not undergone any stretch, said part being considered herein as a non-thermoformed part. The article can be typically obtained by thermoforming a plastic sheet in the material.

The thermoforming is a process known by the one skilled in the art. It typically comprises stretching under heating a plastic material such as a sheet, typically by applying in a mold cavity mechanical means such as plugs and/or by aspiration. The mechanical means can optionally be enhanced by applying a gas under pressure.

The thermoformed part of the article can have a thickness varying in a range of from 50 μm to 2 mm, preferably from 60 μm to 800 μm, preferably from 70 μm to 400 μm.

The material and process finds particular interest in articles presenting at least one or several of the following features:
the article is a container (1) having a hollow body (2) and optionally at least one flange (10), the hollow body defining said thermoformed part, the hollow body being provided with an opening (8);
the hollow body (2) comprises:
   a bottom (3) at the opposite from the opening (8),
   a side wall (2a) presenting at least a portion, preferably a lower portion (13), that is not covered by a banderole (18);
the opening (8) is a generally circular opening and the bottom (3) has a generally circular outer edge;
the side wall (2a) has a generally cylindrical upper portion (12) having a height h2 and a lower portion (13) having a height h1, tapering from the upper portion toward the bottom (3) in a curved manner, the upper portion and the lower portion intersecting and interconnecting at a peripheral intersection line;
the bottom (3) is a planar bottom, and wherein the peripheral intersection line is spaced at a substantially constant distance from the planar bottom, the lower portion (13) having a height h1 corresponding to a minoritary fraction of the height H of the container (1);
the height h2 of said upper portion (12) is constant, the ratio h2/H being comprised between 3:5 and 6:7, and preferably between 2:3 and 4:5;
the ratio h2/H is inferior or equal to 3:4;
the side wall (2a) has a thickness profile such that the average thickness of the lower portion (13) is superior to the average thickness of the upper portion (12); and/or
the opening (8) has an inner diameter which is inferior to the height H of the container (1) and superior to the height h1 of the lower portion (13).

It is mentioned that articles having a lower portion that is not covered by a banderole and are particularly challenging articles as to manufacture, homogeneity and/or mechanical properties, where the use of the mineral filler find a particular interest.

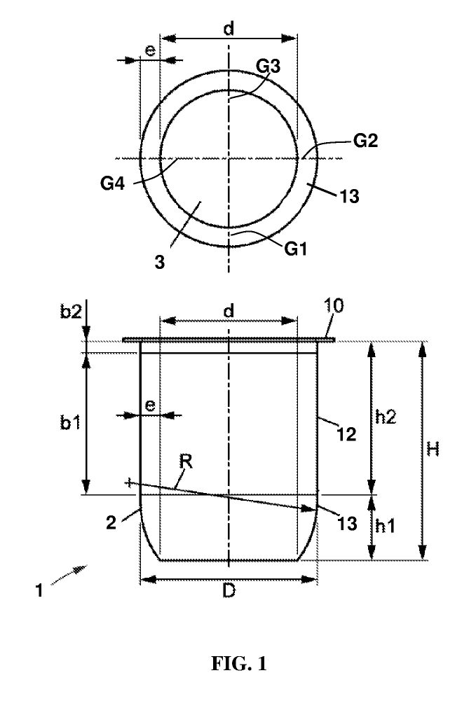

As shown in FIG. 1, the article is preferably a container 1 having a thermoformed part, typically in the form of a hollow body 2, and optionally one or more flanges, for instance an annular flange 10. The hollow body 2 is a thermoformed part that is preferably provided with a continuously rounded section, preferably a circular section. Each flange 10 is typically a non-thermoformed part. In a particular embodiment the hollow body 12 comprises an annular side wall 2a presenting at least one part that is not covered by a banderole 18 or similar decorative strip.

The article can be thermoformed from a sheet having for example a thickness of from 0.6 to 2 mm, preferably from 0.75 to 1.5 mm. The flange if present in the article typically has such a thickness.

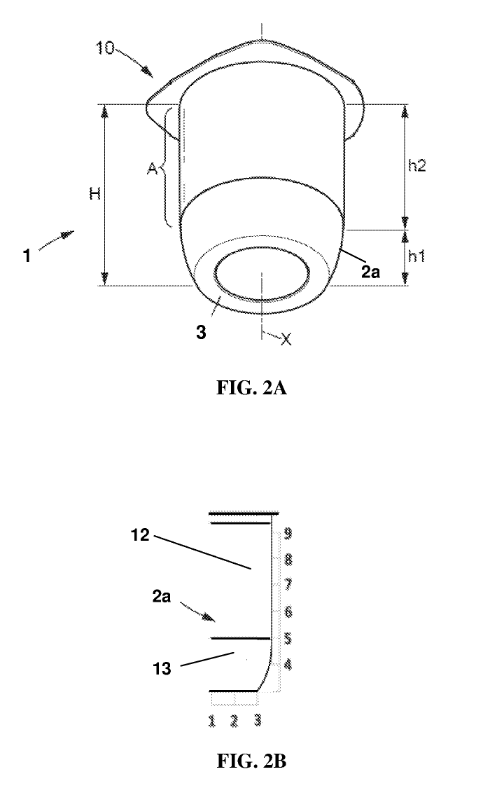

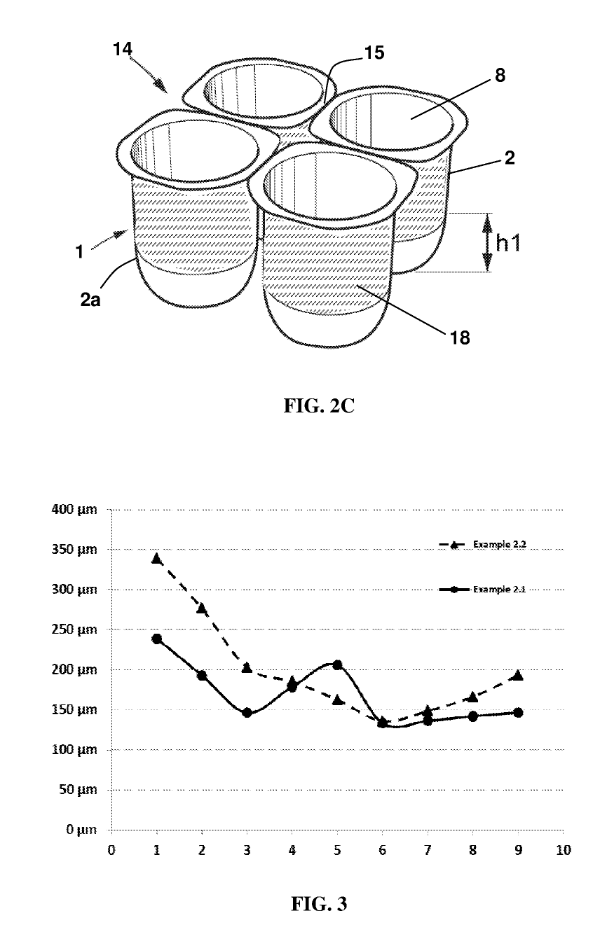

Referring to FIGS. 1 and 2A, the hollow body 2 of the container 1 has a side wall 2a extending along a longitudinal axis X from a bottom 3 as far as an open top. The side wall 2a of the body 2 is tubular and is adapted to be covered by a banderole, preferably a cylindrical banderole or a sticker in the upper area A adjacent to the axial opening 18. In the illustrated non-limitative embodiments, this axial opening is a circular opening 8. More generally, it is understood that the longitudinal axis X is here a central axis for the body 2 and the opening 8. Fixing of the banderole 18 is performed in a known manner.

Here, the container 1 comprises a generally planar annular flange 10 integral with the body 2 and connected to the top of the body 2. The flange 10 radially extends between an inner edge that defines the opening 8 and an outer edge that defines the perimeter of the flange 10. The side wall 2a of the body 2 has a generally cylindrical upper portion 12 directly connected to the flange 10 and a lower portion 13 tapering from the upper portion 12 toward the bottom 3, in a curved manner as clearly apparent in the FIG. 1 and the FIG. 2A.

It can be seen that the upper portion 12 and the lower portion 13 intersect and interconnect at a peripheral intersection line that is here circular. Between the substantially circular junction with the flange 10 and the also substantially circular peripheral intersection line, the upper area A defines a generally cylindrical surface for receiving the banderole 18. The banderole 18 may be added by an in-mold labelling method or the like. A small step or shoulder appropriate for maintaining the decorative strip can be present or absent on the side wall 2a at the peripheral intersection line. Such a step does not protrude more than about 0.5 mm from the cylindrical surface defined by the upper portion 12.

The peripheral intersection line is spaced and at a substantially constant distance from the planar bottom 3 as apparent in FIG. 2A and the height h1 of the lower portion 13 corresponds to a minoritary fraction of the height H of the container 1. It can be appreciated that the height H of the container 1 is larger than the larger size of the hollow body 2. Preferably, the height h2 of the upper portion 12 is not significantly larger than the outer diameter D of the cylindrical upper portion 12 and may be inferior to this outer diameter D as in the examples of FIGS. 1 and 2A-2B for instance. According to any point of view around the container 1, the upper area A can be seen as close to a squared shape, the height h2 of the upper portion 12 being slightly inferior (from max. 15%), equal or not exceeding from more than 10-15% the inner diameter of the opening 8 and/or the outer diameter D or similar apparent width of the body 2. With such an arrangement, the upper portion 12 is particularly useful for displaying information and is typically covered by a rectangular banderole or similar shaped strip arranged in a form of a sleeve label.

Accordingly, the body 2 is higher than wide essentially because of the significant height h1 of the lower portion 13. As this height h1 is significant and for instance comprised between 14 and 24 mm (the height H being for instance not superior to about 65 or 75 mm), the rounded aspect near the bottom 3 is clearly apparent. The lower portion 13 is here continuously rounded from the bottom 3 as far as the peripheral intersection line.

Referring to FIGS. 1 and 2A, the determined area A for attachment of a banderole 18 may have a height b1 not superior to the height h2 of the upper portion 12. An optional small gap thus may exist between the flange 10 and the upper edge, here a rectilinear edge, of the banderole. Here the distance b2 from the flange 10 may be about 1-4 mm only. In the illustrated embodiments, the lower edge of the banderole 18 does not extend below the peripheral intersection line so that the lower potion 13 remains uncovered. The height h2 of the upper portion 12 (of course the height h2 is obtained with h2=H-h1), which is here constant, may represent a fraction of the height H at least equal to 0.6 and not superior to 0.86. The height h1 of the lower portion 13 is thus inferior to a fraction of about ⅖ of the height H. The ratio h1/H may thus be comprised between 0.14 and 0.4. A ratio h2/H comprised between 2:3 and 4:5 and preferably inferior or equal to 3:4 may be chosen. As a result, the rounding of the lower portion 13 is obtained with a soft transition, i.e. with a large radius of curvature R as shown in FIG. 1 and the mechanical properties near the bottom 3 are good without having any specific increase of thickness in the area adjacent the bottom 3. The good mechanical properties such as compression resistance in particular, allow use of a relatively low thickness near the bottom 3 (in the uncovered lower portion 13). The plastic material, comprising the specific combination of polylactic acid and at least one mineral filler, is particularly efficient to form the thermoformed part having a low range of thickness.

In food packaging industry, the plastic containers 1 can be stacked on top of one another so as to form stacks which can be layered on a pallet. A loading weight on a pallet may be much more than 500 kg. Such stacks allow the packaging items at the bottom to withstand the compressive load of the packaging items on top. Accordingly, it is of great interest that the uncovered lower portion 13 (not strengthened in any manner) may withstand high compression. Advantageously, the section of the lower portion 13 is circular as apparent in the top of FIG. 1. More generally, the hollow body 2 may be provided with a circular section, the upper portion 12 having an outer diameter D.

Still referring to FIGS. 1 and 2A, a good compromise between the height of the upper portion 12 and the height of the lower portion 13, in particular for saving plastic material, is obtained when using a ratio h1/H of 0.25-0.27 or 0.27-0.29 or 0.29-0.31. A ratio h1/H superior to 0.2 is preferred to have a less pronounced angle at the junction between the lower portion 32 and the bottom 3. A ratio h1/H not superior to 0.32 is also preferred to have an upper area A sufficient. Furthermore, it is advantageous having a relatively large upper area A at least because a reduction of thickness can be here essentially obtained in the upper portion 30 of the body 2.

Now referring to FIG. 2A, the bottom 3 may be provided with a recess or cavity with a concavity oriented to the exterior. The annular portion of the bottom 3, defined around this cavity, has a diameter inferior to the diameter of the circular opening 8 defined at the top of the body 2. The bottom 3 provided with such cavity, preferably a single centered cavity, has a higher strength for better supporting a compression load. Of course, the bottom 3 may still be considered as a generally planar bottom 3, at least because the bottom 3 has a flat shape and the container 1 is adapted to be maintained vertically when the bottom 3 is in contact with a horizontal base support (the longitudinal axis X being vertical). Of course, the height of the cavity is preferably very small, for instance about 0.5 mm.

Referring to FIG. 1, the upper portion 12 can be seen as cylindrical, thus defining a substantially vertical wall of height h2. Substantially vertical is understood with a tolerance angle of 5° compared to vertical. In the examples shown the upper portion 12 cannot be considered as significantly larger at the top of the body 2 because an angle of less than 2° and for instance of about 1° only is defined with respect to the vertical direction of the longitudinal axis X. This angle is so small than the user will naturally interpret the upper portion 12 as being cylindrical. It can also be appreciated that the outer diameter D of the upper portion 12 can be considered as constant because this angle is typically less than 2° and the height h2 of the upper portion 12 is typically inferior to 50-70 mm. It will thus be understood that D also represents the outer diameter of the peripheral intersection line.

Referring to FIGS. 1, 2A and 2C, the side wall 2a of the body 2 has a generally circular section in cross-section both in the upper portion 12 and in the lower portion 13. In the upper portion 12, generally circular is understood as encompassing circles and ovals with a ratio between the large dimension in cross section and the small dimension in cross section is less than 1.1.

Now referring to FIG. 1, it can be seen that the upper portion 12 determines an imaginary tube, here an imaginary cylinder, extending longitudinally around said longitudinal axis X and having the outer diameter D. Because of the curved shape of the tapered lower portion 13, the bottom 3 of the body 2 has a rounded outer edge that is radially spaced apart from the imaginary tube to define a substantially constant radial distance e between the rounded outer edge and the imaginary tube. The curved shape of the lower portion 13 is obtained with a relatively large radius of curvature R so that the radial distance e is significantly inferior to the half of the diameter d of the bottom 3. Accordingly, the bottom 3 is sufficiently wide to provide a good vertical stability of the container 1 when placed onto a horizontal support. Preferably, the following relation 0.8<d/D<0.9 is satisfied in order to have a stable bottom 3. The ratio e/h1 is comprised between ⅙ and ⅓ and preferably between ⅕ and 3/10 (and more preferably inferior to 0.29). With such a configuration, a slight curvature of the lower portion 13 is obtained and the lower portion 12 provides an additional surface for correctly gripping the container 1. It will be noted that increasing the stretching ratio for the side wall 2a is not something easy to perform when having a relatively thin side wall 2a, especially in the upper portion 12.

Referring to FIG. 1, in order to have good mechanical properties in the lower portion 13 and having efficient stability of the container 1, the radial distance e may be comprised between 3 and 7 mm.

### Containers

The article can be a container, for example a container 1 used as a dairy product container, like a yogurt cup. The invention also concerns the container 1 filled with a food or non-food product, preferably a dairy product, preferably a milk-based (milk being an animal milk or a vegetal milk substitute such as soy milk or rice milk etc. . . . ) product, preferably a fermented dairy product, for example a yogurt. The container 1 can have a yogurt cup shape, for example with a square cross section or a square with rounded corners cross section, or round cross section. The container 1 can have a tapered bottom, preferably a tapered rounded bottom. The container 1 has walls (perpendicular to the cross section), typically a tubular side wall 2a, that can be provided with elements such as stickers or banderoles 18. Elements such as banderoles 18 can contribute to re-enforcing the mechanical resistance of the container.

The container 1 filled with a food or non-food product may comprise a closure element to seal the opening 8. A flange 10 defines a support surface for attachment of the closure element to the containing part of the container 1. The closure element remains above and at a distance from the side wall 2a. A membrane seal or thin foil, optionally suitable for food contact, may form the closure element. When the container 1 is provided with a flange 10, the closure element may have the same general cut as the flange.

The container 1 can be for example a container of 50 ml (or 50 g), to 1 L (or 1 kg), for example a container of 50 ml (or 50 g) to 80 ml (or 80 g), or 80 ml (or 80 g) to 100 ml (or 100 g), or 100 ml (or 100 g) to 125 ml (or 125 g), or 125 ml (or 125 g) to 150 ml (or 150 g), or 150 ml (or 150 g) to 200 ml (or 200 g), or 250 ml (or 250 g) to 300 ml (or 300 g), or 300 ml (or 300 g) to 500 ml (or 500 g), or 500 ml (or 500 g) to 750 ml (or 750 g), or 750 ml (or 750 g) to 1 L (or 1 kg).

### Process

The article can be obtained by thermoforming a plastic sheet made of the material. The material can be prepared before forming the sheet or during the formation of the sheet. Thermoplastic materials, such as PLA, can be introduced in the form of powder, pellets or granules.

Typically the process comprises a step of mixing polylactic acid and the at least one mineral filler. These can be mixed upon forming the sheet, typically in an extruder. One can implement masterbatches with the mineral filler, and one can implement other ingredients such impact modifiers and further additives to be mixed with a thermoplastic material. In another embodiment one can use pre-mixed compounds typically in the form of powder, pellets or granules.

In a preferred embodiment one uses an extracted sheet. Multi-layer sheets can be co-extruded, typically from the corresponding materials in a molten form. Co-extrusion processes are known from the one skilled in the art. These typically involve extruding separates flows through separates side by side dies. Beyond the dies the flows merge and form at least one interface. There is one interface for two-layer articles and two interfaces for three-layer articles. The materials are then cooled to form a solid article.

One can implement appropriate treatments after the extrusion or co-extrusion in order to obtain the desired product, for example a sheet or a film. Treatment steps are for example press treatments, calendering, stretching etc. . . . Parameters of these treatment steps such as temperatures, pressure, speed, number of treatments can be adapted to obtain the desired product, for example a sheet. In one embodiment the article is a sheet prepared by a process involving extruding or co-extruding and calendering.

Thermoforming is a known operation. One can thermoform the sheet so as to obtain the final product of the desired shape. It is mentioned that some stretching occurs upon thermoforming. Total stretching ratios of at least 2.5, preferably at least 3, preferably at least 4, preferably at least 5 are considered as quite high ratios, corresponding to deep thermoforming. The higher the ratio is, the deeper the thermoforming is, the more difficult the control is. The total stretching ratio can be for example of from 2.5 to 8.0, preferably between 3.0 to 7.0, preferably between 4.0 to 6.5. The article can present some local stretching ratios of from 2.5 to 10.0, for example of from 2.5 to 4 and/or from 4 to 6 and/or from 6 to 8 and/or from 8 to 10.

Thermoforming may be for example performed thanks to a Form Fill Seal thermoforming line. The thermoforming can present the following steps:
sheet introduction on guide chains (i.e. spike or jaws);
sheet heating, by heating contact plates;
forming thanks to a negative mold, assisted by forming plugs and air pressure. The mold may comprise or not a label for example a banderole 18. The banderole 18 can be a partial banderole positioned only in the top of the mold, to obtain an article that is covered by the banderole 18 on the upper portion 12 of the body 2 or similar upper area of the thermoformed part, and not covered by the banderole 18 in a lower portion 13. In a Form Fill Seal thermoforming line, one typically performs the following steps after the thermoforming:
the resulting forms are filled with a product, and then, thermosealed with a lid film,
finally, they are cut and optionally precut by one or several mechanical trimming tool(s).

Further details or advantages of the invention might appear in the following non limitative examples.

### EXAMPLES

The examples are implemented with using the following materials:
PLA: Ingeo® 2003D marketed by NatureWorks
Filler 1 (F1): Masterbatch of 60% by weight of PLA and 40% of CaCO₃ treated particles produced from marble (CaCO₃ supplied by Omya having respectively a d₉₈ and d₅₀ of 7 μm and 3 μm).
Impact modifier 1 (IM1): Masterbatch of 75% by weight of PLA and 25% of alkyl, sulfonate, supplied by Sukano.
Impact modifier 2 (IM2): Masterbatch of 50% by weight of PLA and 50% of Biostrength® 150, marketed by Arkema

### Example 1

### Plastic Sheets

Plastic sheets are prepared.

### Example 1.1

### Comparative—“Compact”

A mono-layer PLA plastic sheet is prepared according to the following procedure.

Procedure: The materials (PLA and Impact Modifier1) of the compact layer are extruded with a Fairex extruder having an internal diameter of 45 mm and a 24D length. The temperature along the screw is comprised between 180 and 200° C. The molten PLA is extruded through a die with temperature comprised between 185 and 195° C. to produce a compact sheet. The sheet is then calendered on 3 rolls that get a temperature of 40° C. The obtained sheet has a thickness of 0.85 mm.

### Example 1.2

### PLA+Filler

Bi-layers plastic sheets comprising a pure PLA layer and a PLA+filler layer are prepared according to the following procedure.

Procedure: The multilayer structure is produced by co-extrusion. The materials (PLA, Fillers and optionally Impact Modifier 2) of the PLA+Filler layer are extruded with a Fairex extruder having an internal diameter of 45 mm and a 24D length. The temperature profile along the screw is comprised between 180 and 200° C.

The materials (PLA and masterbatches) of the pure PLA layer are extruded with one Scannex extruder having an internal diameter of 30 mm and a 26D length. The temperature along the screw is comprised between 180 and 200° C. After the extruders, the different PLA flows are fed into feedblock channels through different passages separated by one thin plane (die). At the end of the separation planes, the two flows merge and form one interface, and the sheet is extruded through a die with a temperature comprised between 180 and 190° C. The sheet is then calendered on 3 rolls that get a temperature of 40° C. The obtained sheets have a thickness of 0.85 mm.

Table I below presents compositions of the various sheets and/or layers (contents are provided by weight—as masterbatch or as filler or Impact modifier active).

TABLE I

| | | | | Layer | | | | |
|---|---|---|---|---|---|---|---|---|
| | | Impact | | repartition | Layer repartition | | | Impact |
| | | modifier | | along sheet | along sheet | PLA | | modifier |
| | | (as | | thickness (by | thickness (by | Content (by | Filler content | content (as |
| | Filler | masterbatch) | Layers | distance) | weight) | weight) | (by weight) | active) |
| Example 1.1 | / | IM1 - 4% | Mono-Layer | 100% | 100% | 99% | / | 1% |
| (comparative) | | | | | | | | |
| Example 1.2 | Filler 1 | IM2 - 2% | PLA layer | 8% | 6% | 99% | / | 1% |
| | | IM2 - 4% | PLA + Filler Layer | 92% | 94% | 58% | 40% | 2% |

### Evaluations

All the sheets have a thickness of 850 μm.

The density of the sheets is determined by gravimetric measurements.

Example 1.1: density=1.25

Example 1.2: density=1.56

### Example 2

### Yogurt Cups

The plastic sheets of example 1 are thermoformed into yogurt cups according to the procedure below.

### Procedure:

The sheet is introduced into a F.F.S. thermoforming line and is then thermoformed in 125 g cups with the following parameters:
Heating plates temperatures: 110° C.;
The sheet is gradually heated thanks to six heating steps, each of the heating boxes having a closing time of 140ms;
The thermoforming step is performed with conventional felt forming plugs;
Mold temperature is fixed at 40° C. to activate the label hot melt and to cool down the PLA material;
Forming air pressure: 4.5 bars;
Blowing time: 400 ms
Machine speed: 32 strokes per minute.
Distance between bottom of mold and plug at lowest point: 9 mm
Shape: As shown on FIG. 1. The stretching ratio is 5.6.

The yogurt cups or similar containers 1 are arranged in a pack 14 of 4 attached cups in two rows (the pack being also referred to as a “multipack”) and are cut into ×4 attached cups (referred to as “multipack”), with a precut line 15 or similar junction between each pair of adjacent cups amongst the four cups, as in the example shown in FIG. 2C. The precut lines 15 are performed on the F.F.S. equipment. Various depths are implemented and controlled by operators.

### Evaluations:

The yogurt cup mechanical performances are determined by compression tests referred as Top Load. The Top Load value is evaluated according to the following protocol:
Use of a tensile/compression test machine type ADAMEL LHOMARGY DY 34
Apply compression on cups (by 4 cups) with a speed of 10 mm/min at ambient temperature
Evaluate top load value as: maximum of compression curve.

The thickness profile along a bottom to top line is measured at various equal zones 1 to 9 (here regularly spaced) as shown on FIG. 2B. This is done along for several lines radially along the perimeter, said lines being referred to as G1 to G4 as apparent in FIG. 1 (four lines, orientated at 90° when viewed from the bottom). It can be seen that G3 extends in the opposite direction with respect to G1 and G4 extends in the opposite direction with respect to G2. The zone 1 is at or proximal with respect to a central part of the bottom 3.

The depth of the precut line is measured by optical miscroscopy with at least 3 measurements.

The snapability is determined by hand measurements with a marking scale that represents the ability of the cups to be separated under flexural solicitation:
Mark 0—Do not break in three solicitations or do not follow the precut line;
Mark 1—Break in three solicitations and follow precut line
Mark 3—Break in two solicitations and follow precut line;
Mark 5—Break in one solicitation and follow precut line.

Then, the snapability is compared to the precut depth to determine the minimum precut depth required to obtain a good snapability.

### Results of the Evaluations:

The mechanical performances of the cup are determined from compression measurements:
Example 2.1: Top load=45 daN
Example 2.2: Top load=60 daN

These top load performances are in line with performances required with conventional materials such as polystyrene.
The thickness profile is shown on FIG. 3, reporting the thickness at zones 1 to 9. Example 2.2 has a better controlled thickness profile compared to comparative example 2.1, with a higher thickness in most compression sensitive zone 3.

It has thus been found efficient to have thickness slightly increased in the lower portion 13 (see zones 4 to 5 on FIG. 3) as compared in the half of the upper portion 12 near the connection (see zones 6 to 7 on FIG. 3). In other words, such slight increase at the connection between the upper portion 12 and the lower portion 13 (corresponding to a transition between a straight section and a curved section, typically forming an angle) is efficient to improve the overall mechanical properties of the container 1. It advantageously allows reduction of the amount of plastic material in the bottom part of the hollow body 2. As shown in FIG. 3, it is understood that the side wall 2a has a thickness profile such that the average thickness of the lower portion 13 (here significantly above 160 μm and close to 200 μm) is superior to the average thickness of the upper portion 12 (here about 150 μm or slightly above this value).
The standard deviations when considering the several lines G1 to G4 are as follows:
   Example 2.1: Standard deviation=17.7 μm
Example 2.2: Standard deviation=10.4 μm

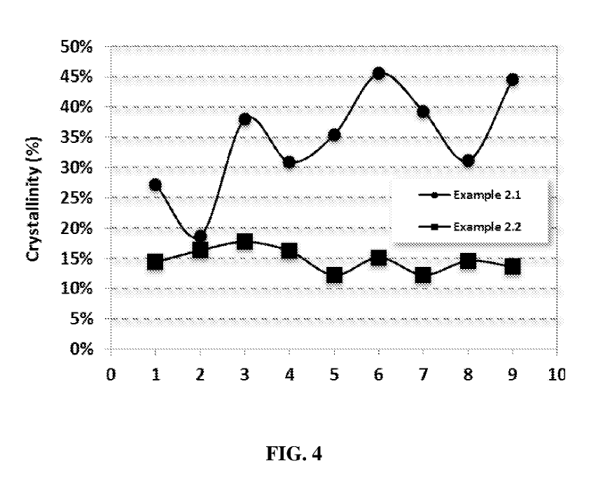

Accordingly the cups present a better homogeneity. The thermoforming control is proved easier.
The crystallinity of the material along the thickness profile have been determined and is shown on FIG. 4. Example 2.2 shows a lower crystallinity compare to the comparative example 2.1. In addition, the results display a better homogeneity of the crystallinity:
Example 2.1: Crystallinity=35%±9%
Example 2.2: Crystallinity=15%±2%

It is believed that this better control of the crystallinity allows a better control of the thickness profile and better Top Load results.
The snapability of the cup has been determined versus the precut depth (FIG. 5):
   Example 2.1: A Snapability mark of 5 requires a precut depth at least 70%
   Example 2.2: Snap ability mark of 5 requires a precut depth at least 30%

This shows that example has an easier snapability, as a short precut depth can be used to obtain a high snapability mark.

1. An article in a material comprising polylactic acid, said article comprising a thermoformed part, wherein:
the material comprises:
from 40% to 90% by weight of poly lactic acid, and
from 10% to 60% by weight of at least at least one mineral filler,
wherein the thermoformed part has a total stretch ratio of at least 2.5.

2. The article according to claim 1, wherein the mineral filler is calcium carbonate.

3. The article according to claim 1, wherein the material comprises from 20% to 50% by weight of the at least one mineral filler.

4. The article according to claim 1, wherein the material is a non-foamed polylactic acid material.

5. The article according to claim 1, wherein the material comprises a non polylactic acid materbatch polymer.

6. The article according to claim 1, wherein the thermoformed part has a thickness varying in a range of from 50 μm to 2 mm.

7. The article according to claim 1, wherein the article is a container (1) having a hollow body (2), the hollow body defining said thermoformed part, the hollow body being provided with an opening (8).

8. The article according to claim 7, wherein the hollow body (2) comprises:
a bottom (3) at the opposite from the opening (8),
a side wall (2a) presenting at least a portion, that is not covered by a banderole (18).

9. The article according to claim 8, wherein said opening (8) is a generally circular opening and the bottom (3) has a generally circular outer edge.

10. The article according to claim 8, wherein the side wall (2a) has a generally cylindrical upper portion (12) having a height h2 and a lower portion (13) having a height h1, tapering from the upper portion toward the bottom (3) in a curved manner, the upper portion and the lower portion intersecting and interconnecting at a peripheral intersection line.

11. The article according to claim 10, wherein the bottom (3) is a planar bottom, and wherein the peripheral intersection line is spaced at a substantially constant distance from the planar bottom, the lower portion (13) having a height h1 corresponding to a minoritary fraction of the height H of the container (1).

12. The article according to claim 11, wherein the height h2 of said upper portion (12) is constant, the ratio h2/H being comprised between 3:5 and 6:7.

13. The article according to claim 11, wherein the ratio h2/H is less than or equal to 3:4.

14. The article according to claim 10, wherein the side wall (2a) has a thickness profile such that an average thickness of the lower portion (13) is greater than the an average thickness of the upper portion (12).

15. The article according to claim 10, wherein said opening (8) has an inner diameter which is less than the height H of the container (1) and greater than the height h1 of the lower portion (13).

16. A process of making an article according to claim 1, comprising the steps of:
a) providing a plastic sheet in the material,
b) thermoforming at least a part of the plastic sheet with a total stretch ratio of at least 2.5.

17. The article according to claim 1, wherein the total stretch ratio of the thermoformed part is at least 3.

18. The article according to claim 1, wherein the total stretch ratio of the thermoformed part is at least 4.

19. The article according to claim 8, wherein the portion is a lower portion (13).

20. The article according to claim 5, wherein the non polylactic acid materbatch polymer is at least one of polyethylene or Ethylene-Vinyl Acetate.
